(19) United States
(12) Patent Application Publication
(10) Pub. No.: US 2017/0213254 A1
(43) Pub. Date: Jul. 27, 2017

(54) AUTOMATICALLY-ADJUSTING ELECTRONIC ADVERTISEMENT SUBSIDY

(71) Applicant: Facebook, Inc., Menlo Park, CA (US)

(72) Inventor: Anand Sumatilal Bhalgat, Mountain View, CA (US)

(21) Appl. No.: 15/003,134

(22) Filed: Jan. 21, 2016

(51) Int. Cl. G06Q 30/02

(52) U.S. Cl. CPC G06Q 30/0275; G06Q 30/0246

(57) ABSTRACT

An online system caps an average amount of subsidy that an ad would receive during the duration of an ad campaign to an average bid price of the ad multiplied by an advertiser subsidy coefficient chosen by the advertiser. For a given impression opportunity, the online system determines a bid price, a user subsidy, and an aggregated subsidy coefficient for an ad. The online system determines the bid price for the ad based on the delivery parameters associated with the ad campaign. The online system determines a user subsidy for the ad based on user interactions with the ad. Furthermore, the online system determines the aggregated subsidy coefficient for the ad based on a ratio between an aggregated subsidy and an aggregated bid price. The amount of subsidy that online system provides to the ad is the user subsidy multiplied by the aggregated subsidy coefficient.

### BACKGROUND

This disclosure relates to online systems, and more specifically to presenting sponsored content items to users of an online system, such as a social networking system.

Online services, such as online systems, search engines, news aggregators, Internet shopping services, and content delivery services, have become a popular venue for presenting advertisements to prospective buyers. Some online services provide their services to users free of charge or charge only minimal fees. To generate revenue, the online services present advertisements (“ads”) to users, who may take certain actions based on the presented ads (e.g., clicking of the ads).

Online services often use a scheme that charges ad fees commensurate with the number of times the ads are displayed to the users or actions taken by the users in response to viewing the ads. The pricing structure widely used in online services for assessing ad fees includes, for example, Cost Per Impression (CPI) and Cost Per Action (CPA). The CPI-based pricing structure assesses ad fees based on the number of instances an ad is loaded and displayed on a user's screen, typically in response to a user's request for a content item. The CPA-based pricing structure assesses ad fees based on actions taken by the users after the ads are displayed on the screen. The actions taken into account for the CPA-based pricing structure may include, among others, the following: (i) clicking on the ad, (ii) registration to the advertiser's service or product, and (iii) conclusion of a sale of a service or product. Rather than using CPI or CPA-based pricing structure, some online services charge a flat fee for displaying an ad for a certain amount of time.

Some online services have adopted a bidding system that allows multiple advertisers to manually bid for an ad space. When an ad is required for a particular ad space, the ad with the highest bidding price is selected and presented in the ad space. The bidding price may be based on CPI, CPA, or other expected revenue values. The context in which an ad is displayed may affect its value to an advertiser and, thus, affect the amount an advertiser is willing to bid for the ad. The context may include the ad being displayed to a high-value user that is likely to click-on, purchase or download an advertised product. To account for variations in context, some online systems have adopted a bidless system where bids are determined for each ad impression based on factors such as campaign budget, time or pacing constraints, impression goals, and/or advertiser prioritized performance weightings. Displaying an ad to a user is referred to herein as an ad “impression.” Accordingly, an ad is selected for display based on a highest determined bid from among the advertisers.

To improve the user-experience relating to advertisements, an advertising system may add a subsidy or “organic bid” to the advertiser's bid for the auction. The subsidy may represent the interests of users of the online system and promote advertisements that are positively interacted with by the users. The subsidy may also be termed an “organic bid” to represent the value to the user of presenting the advertisement, as though it were like other content selected for a user based on a user's interest in the content. The subsidy may greatly increase the advertiser's chance of winning an auction for a particular impression and, therefore, increase the per-ad spend in the ad ecosystem, potentially beyond other advertisers' maximum bids. There is a risk that the subsidy accounts for a large portion of the bid for an advertisement, which may permit an advertisement to receive significant advertising for reduced cost.

In addition, when the subsidy is purely determined based on user interactions with the ad, some advertisers may exploit the online system. For example, some advertisers may post ads that induce user interaction with the ad, but that then direct a user to a page of little value to the user to take advantage of fact that these ads cost the advertisers nothing or almost nothing. In other words, the online system may fully subsidize presentation of some ads that have very little actual value to users and negatively affect the online system's advertising ecosystem. Ads of higher value are less likely to be presented and their advertisers may leave the online system for another advertising venue. Users will become less inclined to interact with ads in general when ads of low value are frequently presented to them. Consequently, the online system receives less revenue from advertising. To offset the advantage received by the advertiser, to relieve the upward pressure being put on system prices, and to ensure ads qualities, there should be a limit imposed on the amount of subsidy received by an ad in an auction.

### SUMMARY

An online system receives a set of delivery parameters (e.g., bid, budget, pace, etc.) for an ad campaign and determines an amount of subsidy or “organic bid” that an ad may receive. The subsidy may increase the advertiser's chance of winning an auction for a particular impression and, therefore, increase the per-ad spend in the ad ecosystem, potentially beyond many advertiser's maximum bids. To prevent the advertiser from over-benefiting from the subsidy, to offset the advantage received by the advertiser, and to relieve the upward pressure being put on advertisement prices, the online system may cap the amount of subsidy that an ad would receive. This cap may automatically adjust according to the amount of subsidy that an ad has already received and the amount of spending by the advertiser.

The average amount of subsidy that an ad would receive during a duration of the ad campaign is capped to the average bid price of the ad multiplied by the advertiser subsidy coefficient α chosen by the online system (e.g., by an operator of the online system). The online system receives ad requests and identifies eligible ad campaigns to provide ads to the ad requests. For each of the identified eligible ad campaigns, the online system determines a bid price, a user subsidy, and an aggregated subsidy coefficient for an ad. The online system determines the bid price for the ad based on the delivery parameters associated with the ad campaign. The bid price is associated with an amount of compensation the advertiser provides to the online system for presenting the ad. The online system determines a user subsidy for the ad based on user interactions with the ad. For example, the online system determines an engagement score associated with an ad to measure a user's interactions with the ad to thereby determine the user subsidy.

Furthermore, the online system determines the aggregated subsidy coefficient for the ad based on a ratio between an aggregated subsidy and an aggregated bid price. The aggregated subsidy for an ad is the total amount of subsidy that the online system provides to the ad during the duration of the ad campaign. The aggregated bid price for an ad is the total amount of bid price the online system determines for the ad during the duration of the ad campaign. The online system determines the aggregated subsidy coefficient by looking up a ratio between an aggregated subsidy and an aggregated bid price in a function. The function defines a value for the aggregated subsidy coefficient γ based on a ratio between an aggregated subsidy for an ad and an aggregated bid price for the ad. The online system determines the subsidy provided to the ad as the user subsidy multiplied by the aggregated subsidy coefficient. In this way, the actual subsidy for the ad is automatically adjusted upward when the advertisement has not been frequently receiving a subsidy, and may be adjusted downward when the advertisement has received significant subsidies relative to the ad spending.

In one embodiment, when the advertiser wins an auction using the subsidy, the advertiser pays the higher of: a) the auction price divided by one plus the advertiser subsidy coefficient α, and b) the auction price minus the subsidy.

### BRIEF DESCRIPTION OF THE DRAWINGS

FIG. 1 is a block diagram illustrating the operation of ad delivery in an ad system, according to one embodiment.

FIG. 2 is a high level block diagram of a system environment suitable for performing ad delivery, according to one embodiment.

FIG. 3 is a flowchart illustrating a process 300 for determining an auction price for an ad, according to one embodiment.

FIG. 4 illustrates an example function defining a value of an aggregated subsidy coefficient based on a ratio between an aggregated subsidy and an aggregated bid price, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

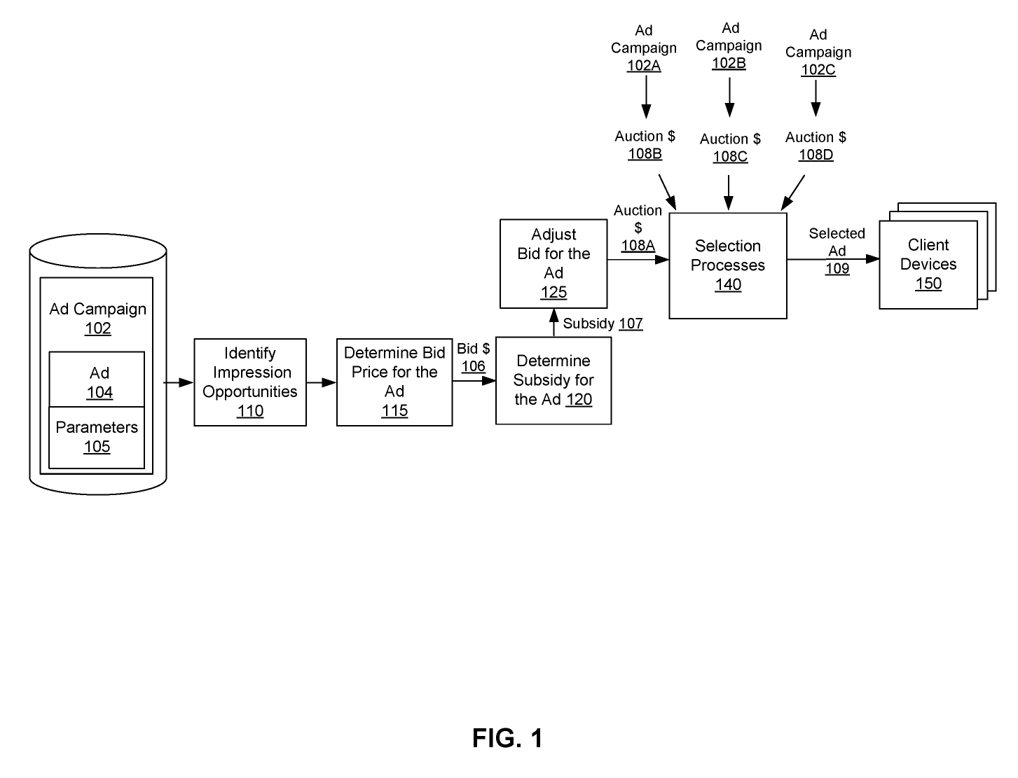

FIG. 1 is a process flow diagram of one embodiment of advertisement (“ad”) delivery by an online system. An online system receives an ad campaign 102 including one or more advertisements (“ads”) 104 for presentation to users of the online system when an opportunity to present one or more ads occurs (i.e., when the online system identifies an “impression opportunity” for one or more ads). The online system receives ad requests from user devices for ads. The ad campaign 102 may be received from a third party system in various embodiments or may be maintained by the online system. The ad campaign 102 may include multiple ads for presentation to users, different targeting criteria identifying characteristics of users eligible to be presented with the ads, and other parameters. For simplicity of explanation, FIG. 1 describes ad campaign 102 as including an ad 104.

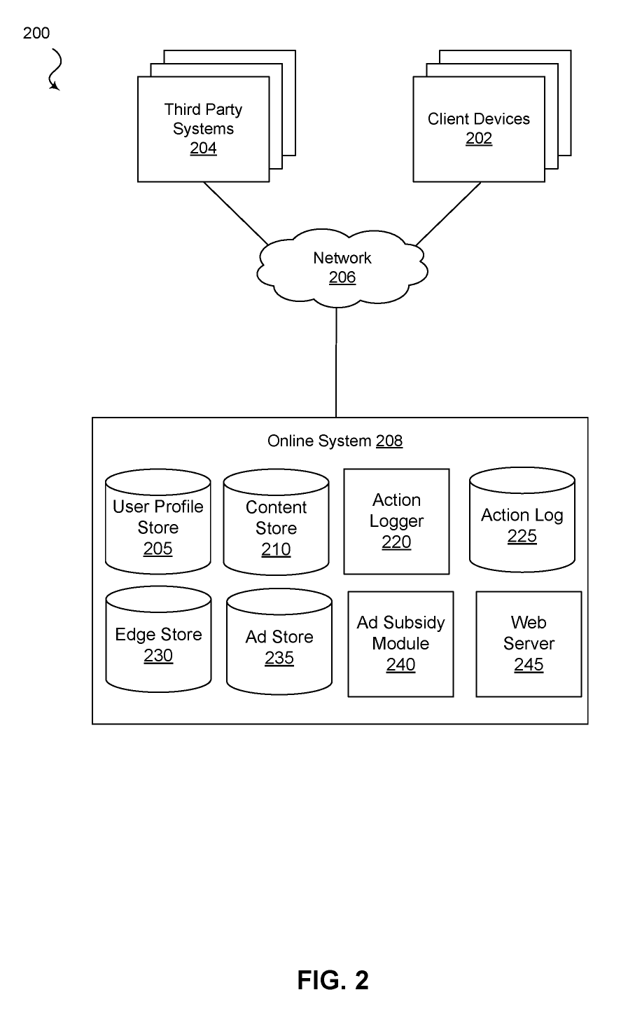

The ad 104 includes content for presentation to users such as one or more images, video, text, or other media. The ad 104 is associated with one or more delivery parameters 105, such as a bid price specifying an amount of compensation the online system receives in exchange for presenting the ad 104, a budget specifying a total amount available for multiple presentations of the ad 104, a time period during which the ad is eligible for presentation to users, or other information. In various embodiments, the delivery parameters 105 are associated with the ad campaign 102. One or more objectives may also be associated with the ad 104 or with an ad campaign 102. An objective describes one or more goals for actions associated with the ad campaign, as further described below in conjunction with FIG. 2. Additionally, one or more goals may be associated with the ad campaign 102. Example goals include: a number of impressions of ads included in the ad campaign 102 desired by an entity associated with the ad campaign 102 or a number of a particular type of interaction performed by users presented with ad requests in the ad campaign 102.

The online system identifies 110 a set of impression opportunities for ads from the ad campaign 102 based on the delivery parameters associated with the ad campaign 102. Each impression opportunity corresponds to an opportunity to present an ad from the ad campaign 102 to a user of the online system responsive to the ad request. In various embodiments, the online system identifies 110 impression opportunities based on user requests for content from the online system, and identifies the ad campaign as targeting users matching characteristics of the user.

The online system determines 115 a bid price 106 for the ad 104 using the delivery parameters 105 associated with the ad campaign 102 for an impression opportunity. That is, the ad is evaluated for presentation via the impression opportunity using the delivery parameters associated with the ad campaign 102. The bid price 106 specifies an amount of compensation an entity associated with the ad campaign 102 will provide to the online system for presenting the ad 104 to a user. In some embodiments, the online system determines the bid price based on an expected revenue to the online system from presenting the ad, a historical conversion rate of the ad, and an amount of revenue received by the online system from prior interactions with the ad. A conversion is a type of interaction with the ad specified by an advertiser as a goal for the ad, so the historical conversion rate identifies a percentage or number of online system users performing a conversion when presented with the ad.

In some embodiments, the online system determines the expected revenue from presenting the ad based on direct revenue received for selecting the ad and based on indirect revenue received from user interaction with the ad. The direct revenue is revenue received by the online system when the ad is selected for presentation, while the indirect revenue is revenue received by the online system from user interacting with the ad. The online system may use historical interactions users have had with the ad to determine the indirect revenue that may be received from presenting the ad. For example, the online system determines indirect revenue by identifying users that previously interacted with the ad within a specified time interval and an amount of revenue received by the online system for each interaction. In one embodiment, indirect revenue is a product of a historical conversion rate for an ad and historical revenue received within a specified time period from interactions with the ad. For example, if the online system earned $8 for each purchase made over the past 60 days and the rate of making a purchase by a user presented with an ad was 0.1 during the 60 days, the indirect revenue to the online system is $0.80 per ad presentation. Various methods may be used to determine the expected revenue, such as a specified function, one or more machine learned models, or other suitable methods. The online system may also associate monetary values with different types of interactions with the ad, allowing the online system to account for user interactions with the ad that do not directly provide revenue to the online system. This allows the online system to account for effects on user engagement with the online system from presenting the ad.

Various factors may affect the expected revenue received by the online system for presenting the ad. Example factors including a duration of the ad campaign during which the ad is presented, a percentage of users presented with the ad, a targeting criteria associated with the ad that may affect the number of users from which indirect revenue may be generated. Accordingly, the indirect revenue from presenting an ad may be scaled by the percentage of online system users eligible to be presented with the ad. In addition, the expected revenue received from presentation of the ad may be proportional to the duration in which the ad is presented, so ads presented to online system users for longer periods of time may provide the online system with greater revenue. User interactions with an ad may also be analyzed to determine the expected revenue from presentation of the ad; for example, changes or trends in user spending habits or application installation are used to adjust the expected revenue from presentation of the ad. Further, as the number of users presented with the ad changes over time, the expected revenue to the online system from presenting the ad changes based on the amount of exposure to the ad.

The online system further determines 120 an amount of subsidy 107 that the ad 104 may receive for the impression opportunity. That is, the online system determines 120 an amount of adjustment (i.e., increase or decrease) to be applied to the determined bid price 106. The online system may determine the amount of subsidy based on the bid price 106, the delivery parameters associated with the ad campaign 102, and/or user interactions with the ad 104. For example, the online system may determine an engagement score associated with an ad that measures a user's interacting with the ad to determine a user subsidy. The engagement score for an ad may be based in part on a measure of a user's expected interaction with the ad. The expected amount of interaction between a user and an ad may be based on specific types of prior actions (e.g., commenting, expressing a preference for a content item, sharing a content item, etc.) by the user associated with previously presented ads as well as other users' interaction with the particular ad. For example, the expected amount of interaction is determined based on the user's prior indications of preference for previously presented ads within a specified time interval, based on the user's accessing of previously presented ads within a specified time interval, or based on other users' interaction with the ad when presented with the ad. In addition, the user's interactions may be predicted based on a computer model that reflects interactions by other users having similar characteristics to the user. This determination may be based on information retrieved from the user profile store 205, the action log 220, or the edge store 225 describing interactions between the user and presented ads as well as between the particular ad and other users. The online system may further determine the engagement score for an ad based in part on a measure of the user's interaction with other ads from the same advertiser and/or other ads in the same campaign.

The online system subsidizes the ad 104 such that an entity associated with the ad campaign 102 does not provide the online system with additional compensation for the amount of subsidy 107. Increasing the bid price 106 may increase a likelihood of the ad 104 being presented to a user via an impression opportunity and represents an expected increase in an amount of compensation provided to the online system for each presentation of an ad (i.e., an average price of an impression or a per-ad spend by entities associated with ad requests). In addition, to offset undue advantage to the entity associated with the ad campaign 102 from increasing the bid used in the auction via the subsidy, and to mitigate potential increases in the average price of an impression, the online system regulates the amount of subsidy 107 by imposing a limit to the amount of subsidy 107 an ad is eligible for. In one example, the online system determines a maximum amount of subsidy by basing the maximum subsidy on the bid price of an advertiser according to Equation (1):

Maximum subsidy amount=α*bid price (1),

where α is an advertiser subsidy coefficient. In some embodiments, the advertiser subsidy coefficient α may be associated with the advertising campaign. An operator of the online system may configure the advertiser subsidy coefficient α for individual advertising campaigns, sets of advertising campaigns, or the system as a whole. The advertiser subsidy coefficient α represents the percentage of an advertiser's bid that the online system is willing to provide relative to the advertiser's bid price. As an example, the advertiser subsidy coefficient α may be 0.5. In this embodiment, for every dollar that an advertiser bids for presentation of an ad, the online system may provide a subsidy up to 50 cents to the ad for an impression opportunity.

In this example, the online system may determine the amount of subsidy 107 according to Equation (2):

subsidy=Min(user subsidy,α*bid price) (2).

That is, the subsidy that the online system provides to an ad for an impression opportunity is limited by a user subsidy and alternatively by the bid price multiplied by the advertiser subsidy coefficient α.

The online system may determine the amount of subsidy 107 using the aggregate bid prices and the aggregate subsidies received by the ad during a duration of the ad campaign 102. In Equation (2), the subsidy is limited by the advertiser subsidy coefficient α. The actual aggregate subsidy provided to the ad may be less than the aggregate bid price multiplied by the advertiser subsidy coefficient α because in some cases the subsidy is capped by the advertiser subsidy coefficient α and in other cases the user subsidy is not high enough to be capped by the advertiser subsidy coefficient α. As one way of permitting the subsidy used in an advertisement to more closely mirror the desired benefit of the advertiser subsidy coefficient α (i.e., for the online system to actually subsidize that portion of the advertisement), the online system may adjust the user subsidy with an aggregated subsidy coefficient γ. This is performed by adjusting the determined user subsidy according to Equation (3):

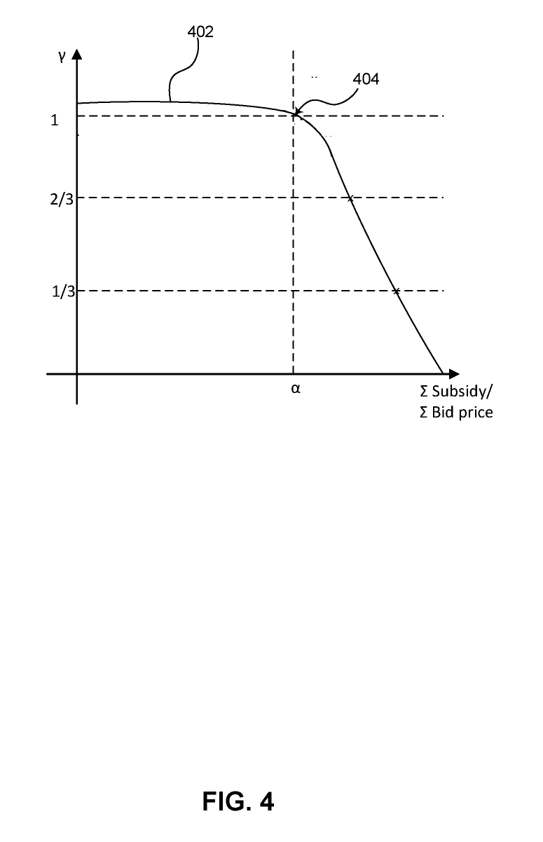

subsidy=γ*user subsidy (3),

where γ is an aggregated subsidy coefficient. The online system may determine the aggregated subsidy coefficient γ from a function that defines a value for the aggregated subsidy coefficient γ based on a ratio between an aggregated subsidy and an aggregated bid price. The function defining the value of the aggregated subsidy coefficient γ may be designed to transition the value of the aggregated subsidy coefficient from a maximum value (such as 1) to a minimum value (such as 0) based on the aggregated subsidy and the aggregated bid price. This function is shown in more detail in FIG. 4. The point on the function at which the aggregated subsidy coefficient γ is reduced from its maximum value (or alternatively, from 1) may be based on the desired advertiser subsidy coefficient α.

Subsequently, the online system adjusts 125 the bid price 106 for the ad to an auction price 108A using the subsidy 107. The online system adjusts 125 the bid price 106 by the determined subsidy 107 to an auction price 108A according to Equation (4):

Auction price 108A=bid price106+subsidy 107 (4).

The online system includes the ad 104 and the associated auction price 108A along with other ad campaigns 102B, 102C, 102D and their respective associated auction prices 108B, 108C, 108D in one or more selection processes 140 for an impression opportunity. The one or more selection processes 140 selects an ad from various ad campaigns for presentation to a user via one or more client devices 150 for the impression opportunity. The one or more selection processes 140 compares the auction price 108A and the auction prices 108B through D for the ad request to select an ad 109 for the impression opportunity. The one or more selection processes 140 communicate the selected ad 109 from an ad request to the client device 150 for display to a user. The selection process may select an ad using a variety of auction types, and may use a highest-bid auction, a Vickrey-Clarke-Groves auction, or another type of auction.

If the ad 104 is the selected ad 109 and wins the auction with the bid price 106, the bid price 106 is a higher of the auction price 108A divided by a sum of the advertiser subsidy coefficient α and 1, and the auction price 108A minus the subsidy 107 according to Equation (5):

Bid price106=Max(auction price/(1+α),(auction price−subsidy)) (5).

The advertiser provides this amount to the online system for presenting the ad 104 to a user. As such, the online system prevents the advertiser from paying nothing or almost nothing for presenting ads.

### System Architecture

FIG. 2 is a block diagram of system environment 200 for online system 208. System environment 200 shown by FIG. 2 comprises one or more client devices 202, one or more third-party systems 204, a network 206, and an online system 208. In alternative configurations, different and/or additional components may be included in the system environment 200. The embodiments described herein can be adapted to online systems that are not online systems.

The client devices 202 are one or more computing devices capable of receiving user input as well as transmitting and/or receiving data via the network 206. In one embodiment, the client device 202 is a conventional computer system, such as a desktop or a laptop computer. Alternatively, the client device 202 may be a device having computer functionality, such as a personal digital assistant (PDA), a mobile telephone, a smartphone or another suitable device. The client device 202 is configured to communicate via the network 206. In one embodiment, the client device 202 executes an application allowing a user of the client device 202 to interact with the online system 208. For example, the client device 202 executes a browser application to enable interaction between the client device 202 and the online system 208 via the network 206. In another embodiment, the client device 202 interacts with the online system 208 through an application programming interface (API) running on a native operating system of the client device 202, such as IOS® or ANDROID™. The client devices 202 are configured to communicate via the network 206, which may comprise any combination of local area and/or wide area networks, using both wired and/or wireless communication systems.

One or more third party systems 204 may be coupled to the network 206 for communicating with the online system 208. In one embodiment, a third party system 204 is an application provider communicating information describing applications for execution by a client device 202 or communicating data to client devices 202 for use by an application executing on the client device. In other embodiments, a third party system 204 provides content or other information for presentation via a client device 220. A third party system 204 may also communicate information to the online system 208, such as ads, content, or information about an application provided by the third party system 204.

In one embodiment, the network 206 uses standard communications technologies and/or protocols. For example, the network 206 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 206 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 206 may be represented using any suitable format, such as hypertext markup language (HTML) or extensible markup language (XML). In some embodiments, all or some of the communication links of the network 206 may be encrypted using any suitable technique or techniques.

The online system 208 shown in FIG. 2 includes a user profile store 205, a content store 210, an action logger 220, an action log 225, an edge store 230, an ad (“ad”) store 235, an ad subsidy module 240, and a web server 245. In other embodiments, the online system 208 may include additional, fewer, or different components for various applications. Conventional components such as network interfaces, security functions, load balancers, failover servers, management and network operations consoles, and the like are not shown so as to not obscure the details of the system architecture.

Each user of the online system 208 is associated with a user profile, which is stored in the user profile store 205. A user profile includes declarative information about the user that was explicitly shared by the user and may also include profile information inferred by the online system 208. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 225.

While user profiles in the user profile store 205 are frequently associated with individuals, allowing individuals to interact with each other via the online system 208, user profiles may also be stored for entities such as businesses or organizations. This allows an entity to establish a presence on the online system 208 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 208. In one embodiment, objects in the content store 210 represent single pieces of content, or content “items.” Hence, online system users are encouraged to communicate with each other by posting text and content items of various types of media to the online system 208 through various communication channels. This increases the amount of interaction of users with each other and increases the frequency with which users interact within the online system 208.

The action logger 225 receives communications about user actions internal to and/or external to the online system 208, populating the action log 225 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 225.

The action log 225 may be used by the online system 208 to track user actions on the online system 208, as well as actions on third party systems 204 that communicate information to the online system 208. Users may interact with various objects on the online system 208, and information describing these interactions is stored in the action log 225. Examples of interactions with objects include: commenting on posts, sharing links, checking-in to physical locations via a mobile device, accessing content items, and any other suitable interactions. Additional examples of interactions with objects on the online system 208 that are included in the action log 225 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 225 may record a user's interactions with ads on the online system 208 as well as with other applications operating on the online system 208. In some embodiments, data from the action log 225 is used to infer interests or preferences of a user, augmenting the interests included in the user's user profile and allowing a more complete understanding of user preferences.

The action log 225 may also store user actions taken on a third party system 204, such as an external website, and communicated to the online system 208. For example, an e-commerce website may recognize a user of an online system 208 through a social plug-in enabling the e-commerce website to identify the user of the online system 208. Because users of the online system 208 are uniquely identifiable, e-commerce websites, such as in the preceding example, may communicate information about a user's actions outside of the online system 208 to the online system 208 for association with the user. Hence, the action log 225 may record information about actions users perform on a third party system 204, including webpage viewing histories, ads that were engaged, purchases made, and other patterns from shopping and buying.

In one embodiment, the edge store 230 stores information describing connections between users and other objects on the online system 208 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 208, such as expressing interest in a page on the online system 208, sharing a link with other users of the online system 208, and commenting on posts made by other users of the online system 208.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 208, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 230 also stores information about edges, such as affinity scores for objects, interests, and other users. Affinity scores, or “affinities,” may be computed by the online system 208 over time to approximate a user's interest in an object or another user in the online system 208 based on the actions performed by the user. A user's affinity may be computed by the online system 208 over time to approximate a user's interest for an object, interest, or other user in the online system 208 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 230, in one embodiment. Alternatively, each interaction between a user and a specific object is stored as a separate edge. In some embodiments, connections between users may be stored in the user profile store 205, or the user profile store 205 may access the edge store 230 to determine connections between users.

The ad store 235 stores information describing ad campaigns received from one or more advertisers. Each ad campaign includes one or more ads described by ad requests, so the ad store 235 also includes information describing various ad requests comprising ad campaigns. An ad campaign is associated with a set of delivery parameters (e.g., a budget, impression goal, a target average price paid, etc.) Additionally, an ad campaign may be associated with one or more objectives and a duration.

A target average price paid represents an amount of compensation an advertiser desires to pay the online system 208 per action associated with ads in the ad campaign. For example, the target average price paid specifies an average amount of compensation the advertiser seeks to provide the online system 208 for each presentation of an ad in the ad campaign to an online system user (an “impression”) or for each conversion event associated with an ad from the ad campaign presented to an online system user (e.g., an interaction with an ad, an interaction with an object associated with an ad, etc.).

The budget represents a total amount of revenue an advertiser has allocated to compensate the online system 208 for presenting ads in an ad campaign. An amount is deducted from the budget each time an ad from an ad campaign is presented and an action associated with the ad by an advertiser occurs (e.g., an impression of an ad, a conversion event associated with the ad). When the budget is exhausted, the online system 208 ceases presentation of ads from an ad campaign associated with the budget.

An objective associated with an ad campaign describes one or more goals for actions associated with the ad campaign. For example, an objective specifies a total number of impressions of ads in the ad campaign to online system users (an “impression objective”), specifies a total number of unique online system users to be presented with at least one ad from the ad campaign (a “reach objective”), a number of times an ad from the ad campaign is presented to an online system user (a “frequency objective”), or any other suitable criteria. Additionally, the duration associated with the ad campaign specifies a time interval during which ads from the ad campaign are presented to online system users. For example, if the duration of an ad campaign is 30 days, ads included in the ad campaign are presented to online system users for 30 days after the ad campaign is provide to the online system 208 or until the budget is exhausted. In some embodiments, the advertiser specifies a start date for the ad campaign, so the duration is measured from the specified start date.

An ad campaign includes one or more ads for presentation to one or more online system users. An ad includes ad content, which is text, image, audio, video, or any other suitable data presented to a user. In various embodiments, the ad content is associated with a network address specifying a landing page, or other destination, to which a user is directed when the ad is accessed. A bid price is also associated with each ad and represents an amount of compensation, such as monetary compensation, an advertiser associated with the advertising request provides the online system 208 in exchange for presentation of the ad described by the ad request. For advertisements that compensate the online system based on actions performed by a user who receives the ad, the bid price may be a conversion of the payment per-action to an expected value for providing an ad impression. An expected value to the online system 208 of presenting an ad may be determined based on the bid price associated with a corresponding ad request or based on the bid price and a likelihood of a user interacting with the ad if it is presented to the user. Examples of actions associated with a bid price include presenting an ad to a user, receiving a user interaction with the ad, receiving a user interaction with an object associated with the ad, or any other suitable condition. For example, the bid price specifies a maximum monetary amount that the online system 208 receives from the advertiser if an action is performed and the expected value is determined by multiplying the bid price by a probability of the user interacting with the ad.

Additionally, an ad request may include one or more targeting criteria specified by the advertiser. The targeting criteria included in an ad request specify one or more characteristics of users eligible to be presented with ad content associated with the ad request. For example, the targeting criteria are used to identify users having user profile information, edges or actions satisfying at least one of the targeting criteria. Hence, the targeting criteria allow an advertiser to identify users having specific characteristics, simplifying subsequent distribution of ad content to different users. Additionally, the targeting criteria may be associated with an ad campaign as a whole, so multiple ads in the ad campaign are eligible to users having characteristics satisfying one or more of the targeting criteria associated with the ad campaign.

In one embodiment, one or more targeting criteria may specify actions or types of connections between a user and another user or object of the online system 208. The targeting criteria may also specify interactions between a user and objects performed external to the online system 208, such as on a third party system 204. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 204, or any other suitable action. Including actions in targeting criteria allows advertisers to further refine users eligible to be presented with ad content in an ad request that includes the targeting criteria. As another example, the targeting criteria identify users having a connection to another user or object or having a particular type of connection to another user or object.

The ad subsidy module 240 determines an amount of subsidy that an ad receives. The online system 208 subsidizes the ad to promote content that may be desirable for users of the online system 208. The subsidy increases the advertiser's chance of winning an auction to support such content that may be desirable for users to view. To prevent some advertisers from luring user to interact with ads thereby to fully rely on subsidy provided by the online system 208 to present ads to users, to offset the advantage received by the advertiser, and also to relieve upward pressure being put on system prices, the ad subsidy module 240 limits the amount of subsidy that an ad receives. The ad subsidy module 240 may determine an aggregated subsidy coefficient γ and a user subsidy. The ad subsidy module 240 may determine the amount of subsidy the ad receives as a product of the aggregated subsidy coefficient γ and the user subsidy.

The ad subsidy module 240 may determine the user subsidy based on user interaction with an ad. For example, the ad subsidy module 240 determines an engagement score associated with an ad to measure the user's interacting with the ad thereby to determine the user subsidy. The ad subsidy module 240 determines a bid price for an ad. For example, for an impression opportunity, the ad subsidy module 240 determines a bid price for an ad using the delivery parameters associated with the ad campaign. The bid price specifies an amount of compensation an entity associated with the ad campaign will provide to the online system 208 for presenting the ad to a user. The bid price may be adjusted upwards or downwards during an ad campaign if the ad campaign is paced. A paced ad campaign increases or decreases the bid for the ad campaign to spend the budget for the campaign evenly during the length of the campaign. Furthermore, the ad subsidy module 240 determines a subsidy amount that the ad is eligible for as a product of an aggregated subsidy coefficient and the user subsidy as further described above with respect to Equations (2)-(3).

The ad subsidy module 240 further determines an auction price for the ad. The auction for the ad is the determined bid price plus the determined amount of subsidy. The auction price is used when comparing the ad to other ads for an impression opportunity. For example, for the impression opportunity, the ads are compared based in part on their auction prices to select an ad to present. Advertisement bidding is further described in U.S. patent application Ser. No. 13/294,094 entitled “Budget-Based Bidding in a Social Networking System,” filed on Nov. 10, 2011, and is incorporated by reference in its entirety.

The web server 245 links the online system 208 via the network 206 to the one or more client devices 220, as well as to the one or more third party systems 204. The web server 245 serves web pages, as well as other content, such as JAVA®, FLASH®, XML and so forth. The web server 245 may receive and route messages between the online system 208 and the client device 220, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

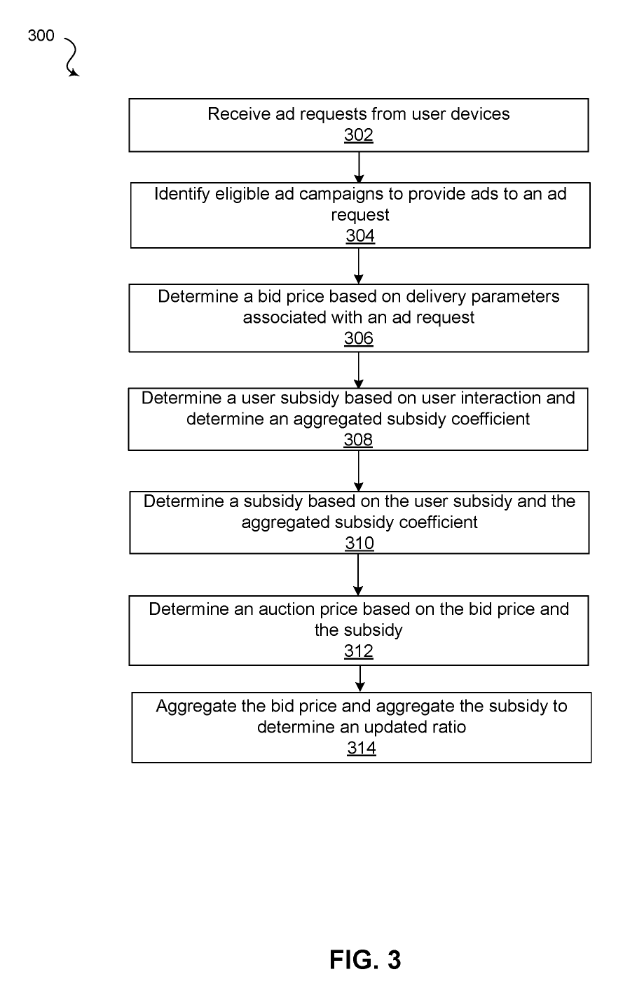

FIG. 3 is a flowchart illustrating a process 300 for determining an auction price for an ad, in accordance with an embodiment. In various embodiments, the steps described in conjunction with FIG. 3 may be performed in different orders. Additionally, in various embodiments the method may include different and/or additional steps than those described in conjunction with FIG. 3.

An online system receives 302 ad requests from user devices. In various embodiments, an advertiser provides one or more ad campaigns to an online system. Ad campaigns are provided with a set of delivery parameters associated with the ad campaign. The set of delivery parameters include an associated ad budget, ad goals, and/or pacing. Ad goals include a target number of impressions for the ad, for instance over a particular time period for which the ad may be displayed. The pacing allows an advertiser to control a pace of the ad requests being selected over the duration of the ad campaign. An operator of the online system may set an advertiser subsidy coefficient α for the ad, which is a constant used to limit an amount of subsidy that an advertiser may receive from the online system. The received ads, the set of delivery parameters (e.g., an ad budget, ad goals, pacing), and the advertiser subsidy coefficient α, may be stored in an ad database on the online system. In response to receiving an ad request, the remaining ad budget and the pacing of the ad goals are determined for each of a plurality of ads. The online system identifies 304 eligible ad campaigns to provide ads to the ad requests. For each of the identified eligible ad campaigns, the online system determines an auction price as indicated below, and the eligible ad campaigns compete in an auction for selection of an advertisement to fulfill the ad request. In some embodiments, the online system does not select an ad campaign as an eligible ad campaign based on the budget or the desired number of impressions or time frame for the ad campaign.

The online system determines 306 a bid price for an ad of an ad campaign for an ad request based on the received set of delivery parameters. The online system determines 308 a user subsidy based on user interaction and also determines an aggregated subsidy coefficient. The online system may determine the user subsidy by measuring a user's interaction with the ad. For example, the online system determines an engagement score associated with the ad to measure a user's interaction with the ad.

The online system determines an aggregated subsidy coefficient γ based on a ratio between an aggregated subsidy for the ad and an aggregated bid price for the ad (“the ratio”). This ratio represents the extent to which the online system has already subsidized the advertisement relative to bid prices of the advertiser. The aggregated subsidy for the ad is a sum of all subsidy provided by the online system to the ad during the duration of the ad campaign. The aggregated bid price for the ad is a sum of all bid prices of the ad during the duration of the ad campaign. In some examples, the aggregated subsidy and bid price are aggregated with respect to auctions that have been won by the ad campaign, rather than ad requests for which the ad campaign bid. The online system identifies the aggregated subsidy coefficient γ in a function defining a value for the aggregated subsidy coefficient γ based on a ratio between an aggregated subsidy for an ad and an aggregated bid price for the ad.

Referring to FIG. 4 illustrating an example function 402 defining a value for the aggregated subsidy coefficient γ based on a ratio between an aggregated subsidy for an ad and an aggregated bid price for the ad. As illustrated, the function includes an infliction point 404 that corresponds to the ratio equaling to an advertiser subsidy coefficient α chosen by the advertiser. When the ratio is less than the advertiser subsidy coefficient α for the ad campaign, the aggregated subsidy coefficient γ is greater than or equal to 1, reflecting that the ad may receive the full benefit, or more, of the determined user subsidy. When the ratio is greater than the advertiser subsidy coefficient α, the aggregated subsidy coefficient is less than or equal to 1, reflecting that the ad has already received, in aggregate, the desired subsidy for its ad campaign. The instantaneous rate of change in γ to that of the ratio is much higher for a ratio higher than the advertiser subsidy coefficient α than for a ratio less than the advertiser subsidy coefficient α. The online system considers the total amount of subsidy that the ad has received and the total amount of bid prices of the ad during the duration of an ad campaign when determining the amount of subsidy that an ad would receive for an impression opportunity. Responsive to determining that an average amount of subsidy that an ad has received during the duration of an ad campaign is less (greater) than the average bid price of the ad multiplied by the subsidy coefficient α, the online system increases (decreases) the amount of subsidy the ad would receive for an impression opportunity. As such, over the time during the duration of an ad campaign, the average amount of subsidy that the online system provides to an ad converges to the average price of the ad multiplied by the advertiser subsidy coefficient α. After the inflection point, the function for determining the aggregated subsidy coefficient γ may decrease to approach or reach zero, indicating that the advertising campaign will not receive any further subsidy.

The online system may determine the function 402 for an aggregated subsidy coefficient γ. The function 402 may be an asymptotic or other functions selected by the online system or its operators to smooth the reduction of the subsidy after the advertiser subsidy coefficient α.

Referring back to FIG. 3, the online system determines 310 a subsidy based on the determined user subsidy and the determined aggregated subsidy coefficient γ. The online system multiplies the determined user subsidy by the determined aggregated subsidy coefficient γ to determine the subsidy. The determined subsidy is capped to a maximum subsidy amount equaling to the bid price multiplied by an advertiser subsidy coefficient.

The online system determines 312 an auction price based on the bid price and the subsidy. The auction price equals to a sum of the bid price and the subsidy. The online system subsequently determines 314 an updated aggregated bid price and an updated subsidy thereby to determine an updated ratio between the updated aggregated subsidy and the updated aggregated bid price. The online system adds the determined bid price to the existing aggregated bid price to determine the updated aggregated bid price. The online system adds the determined subsidy to the existing aggregated subsidy to determine the updated aggregated subsidy. The online system may use the updated ratio to determine an updated aggregated subsidy coefficient γ for another impression opportunity. Over the time, the aggregated subsidy coefficient γ converges to 1. That is, the ratio between the aggregated subsidy and the aggregated bid price converges to the advertiser subsidy coefficient α. The average subsidy that an advertiser receives from the online system for an ad is the average bid price the online system determines for the ad multiplied by the advertiser subsidy coefficient α.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, by an online system, one or more advertisement (ad) campaigns associated with a set of delivery parameters, specified by an advertiser, for ads of the ad campaign;
identifying, by the online system, a plurality of ad requests to present one or more ads for the ad requests in the ad campaign to users of the online system based on at least one delivery parameter of the set of delivery parameters;
for each ad request of the plurality of ad requests and for each ad campaign of the one or more ad campaigns:
determining, by the online system, a bid price for the ad based on at least one delivery parameter of the set of delivery parameters specified by the advertiser,
determining, by the online system, a subsidy for the ad based on user interactions with the ad and an aggregated subsidy coefficient for the ad, the aggregated subsidy coefficient determined by using a ratio between an aggregated subsidy for the ad to an aggregated bid price for the ad, and
determining, by the online system, an auction price for the ad by adjusting the determined bid price with the determined subsidy; and
including, by the online system, the one or more ads with the determined auction prices in one or more selection processes selecting ads for presentation to users of the online system via the plurality of ad requests.

2. The method of claim 1, further comprising determining an updated aggregated subsidy coefficient for an ad by adding the determined subsidy for the ad to the aggregated subsidy, determining an updated aggregated bid price for the ad by adding the determined auction price for the ad to the aggregated bid price, and determining an updated ratio by dividing the updated aggregated subsidy by the updated aggregated bid price for the ad.

3. The method of claim 2, further comprising determining an updated subsidy for the ad for another impression opportunity by using the updated ratio between the updated aggregated subsidy for the ad to the updated aggregated bid price for the ad.

4. The method of claim 1, further comprising identifying the aggregated subsidy coefficient for the ad by looking up the ratio between an aggregated subsidy for the ad to the aggregated bid price for the ad in a function defining a value for the aggregated subsidy coefficient based on the ratio.

5. The method of claim 1, further comprising receiving an advertiser subsidy coefficient for the ad, wherein the determined subsidy for the ad converges to the advertiser subsidy over time, and the advertiser subsidy is a product of the advertiser subsidy coefficient and the bid price.

6. The method of claim 1, wherein the set of delivery parameters comprises a budget and a desired number of impression of ads, and the determining the bid price for the ad comprises determining the bid price based at least in part on the budget and the desired number of impressions of ads included in the ad campaign.

7. The method of claim 1, wherein the determining the subsidy for the ad comprises determining a user subsidy based on the user interactions, and wherein the subsidy is a product of the aggregated subsidy coefficient and the user subsidy.

8. The method of claim 7, wherein the determining the user subsidy comprises determining an expected user interaction with the ad.

9. A system comprising:
a processor; and
a non-transitory computer readable storage medium having instructions encoded thereon that, when executed by the processor, cause the processor to:
receive, by an online system, one or more advertisement (ad) campaigns associated with a set of delivery parameters, specified by an advertiser, for ads of the ad campaign;
identify a plurality of ad requests to present one or more ads for the ad requests in the ad campaign to users of the online system based on at least one delivery parameter of the set of delivery parameters;
for each ad request of the plurality of ad requests and for each ad campaign of the one or more ad campaigns:
determine a bid price for the ad based on at least one delivery parameter of the set of delivery parameters specified by the advertiser;
determine a subsidy for the ad based on user interactions with the ad and an aggregated subsidy coefficient for the ad, the aggregated subsidy coefficient determined by using a ratio between an aggregated subsidy for the ad to an aggregated bid price for the ad; and
determine an auction price for the ad by adjusting the determined bid price with the determined subsidy; and
include the one or more ads with the determined auction prices in one or more selection processes selecting ads for presentation to users of the online system via the plurality of ad requests.

10. The system of claim 9, wherein the instructions are further configured to cause the processor to determine an updated aggregated subsidy coefficient for an ad by adding the determined subsidy for the ad to the aggregated subsidy, determine an updated aggregated bid price for the ad by adding the determined auction price for the ad to the aggregated bid price, and determine an updated ratio by dividing the updated aggregated subsidy by the updated aggregated bid price for the ad.

11. The system of claim 10, wherein the instructions are further configured to cause the processor to determine an updated subsidy for the ad for another impression opportunity by using the updated ratio between the updated aggregated subsidy for the ad to the updated aggregated bid price for the ad.

12. The system of claim 9, wherein the instructions are further configured to cause the processor to identify the aggregated subsidy coefficient for the ad by looking up the ratio between an aggregated subsidy for the ad to the aggregated bid price for the ad in a function defining a value for the aggregated subsidy coefficient based on the ratio.

13. The system of claim 9, wherein the instructions are further configured to cause the processor to receive an advertiser subsidy coefficient for the ad, the determined subsidy for the ad converges to the advertiser subsidy over time, and the advertiser subsidy is a product of the advertiser subsidy coefficient and the bid price.

14. The system of claim 9, wherein the set of delivery parameters comprises a budget and a desired number of impression of ads, and the determining the bid price for the ad comprises determining the bid price based at least in part on the budget and the desired number of impressions of ads included in the ad campaign.

15. The system of claim 9, wherein the determining the subsidy for the ad comprises determining a user subsidy based on the user interactions, and wherein the subsidy is a product of the aggregated subsidy coefficient and the user subsidy.

16. The system of claim 15, wherein the determining the user subsidy comprises determining an expected user interaction with the ad.

17. A computer-readable storage medium having instructions encoded thereon that, when executed by a processor, cause the processor to:
receive, by an online system, one or more advertisement (ad) campaigns associated with a set of delivery parameters, specified by an advertiser, for ads of the ad campaign;
identify a plurality of ad requests to present one or more ads for the ad requests in the ad campaign to users of the online system based on at least one delivery parameter of the set of delivery parameters;
for each ad request of the plurality of ad requests and for each ad campaign of the one or more ad campaigns:
determine a bid price for the ad based on at least one delivery parameter of the set of delivery parameters specified by the advertiser;
determine a subsidy for the ad based on user interactions with the ad and an aggregated subsidy coefficient for the ad, the aggregated subsidy coefficient determined by using a ratio between an aggregated subsidy for the ad to an aggregated bid price for the ad; and
determine an auction price for the ad by adjusting the determined bid price with the determined subsidy; and
include the one or more ads with the determined auction prices in one or more selection processes selecting ads for presentation to users of the online system via the plurality of ad requests.

18. The computer-readable storage medium of claim 17, wherein the instructions are further configured to cause the processor to determine an updated aggregated subsidy coefficient for an ad by adding the determined subsidy for the ad to the aggregated subsidy, determine an updated aggregated bid price for the ad by adding the determined auction price for the ad to the aggregated bid price, and determine an updated ratio by dividing the updated aggregated subsidy by the updated aggregated bid price for the ad.

19. The computer-readable storage medium of claim 17, wherein the instructions are further configured to cause the processor to determine an updated subsidy for the ad for another impression opportunity by using the updated ratio between the updated aggregated subsidy for the ad to the updated aggregated bid price for the ad.

20. The computer-readable storage medium of claim 19, wherein the instructions are further configured to cause the processor to identify the aggregated subsidy coefficient for the ad by looking up the ratio between an aggregated subsidy for the ad to the aggregated bid price for the ad in a function defining a value for the aggregated subsidy coefficient based on the ratio.

21. The computer-readable storage medium of claim 17, wherein the instructions are further configured to cause the processor to determine an advertiser subsidy coefficient for an ad provided by an advertiser, the determined subsidy for the ad converges to the advertiser subsidy over time, and the advertiser subsidy is a product of the advertiser subsidy coefficient and the bid price.
